(19) United States
(12) Patent Application Publication
(10) Pub. No.: US 2009/0062524 A1
(43) Pub. Date: Mar. 5, 2009

(54) METHOD FOR BREAKING DOWN CELLULOSE IN SOLUTION

(75) Inventors: Klemens Massonne, Bad Durkheim (DE); Giovanni D'Andola, Heidelberg (DE); Veit Stegmann, Mannheim (DE); Werner Mormann, Siegen (DE); Markus Wezstein, Kirchhundem (DE); Wei Leng, Siegen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/281,786

(22) PCT Filed: Feb. 28, 2007
(86) PCT No.: PCT/EP2007/051870

§ 371 Date: Sep. 5, 2008

(30) Foreign Application Priority Data
Mar. 8, 2006 (DE) 102006011075.7

(51) Int. Cl. C08B 11/02; C08B 11/12; C08B 3/06; C08B 3/08; C08B 3/00

(52) U.S. Cl. 536/68; 536/99; 536/98; 536/69; 536/63

(57) ABSTRACT

The present invention describes a process for the degradation of cellulose by dissolving the cellulose in an ionic liquid and treating it with an acid, if appropriate with addition of water.

The present invention describes a process for the degradation of cellulose by dissolving the cellulose in an ionic liquid and treating it with an acid, if appropriate with addition of water.

Cellulose is the most important renewable raw material and represents an important starting material for, for example, the textile, paper and nonwovens industry. It also serves as raw material for derivatives and modifications of cellulose, including cellulose ethers such as methylcellulose and carboxymethylcellulose, cellulose esters based on organic acids, e.g. cellulose acetate, cellulose butyrate, and also cellulose esters based on inorganic acids, e.g. cellulose nitrate, and others. These derivatives and modifications have a variety of uses, for example in the food industry, building industry and surface coatings industry.

Cellulose is characterized by insolubility, in particular in customary solvents of organic chemistry. In general, N-methylmorpholine N-oxide, anhydrous hydrazine, binary mixtures such as methylamine/dimethyl sulfoxide or ternary mixtures such as ethylenediamine/SO₂/dimethyl sulfoxide are nowadays used as solvents. However, it is also possible to use salt-comprising systems such as LiCl/dimethylacetamide, LiCl/N-methylpyrrolidone, potassium thiocyanate/dimethyl sulfoxide, etc.

Rogers et al. have recently reported (J. Am. Chem. Soc. 124, 4974 (2002)), that cellulose is soluble in ionic liquids such as [1-butyl-3-methylimidazolium] chloride.

Cellulose is usually characterized by the average degree of polymerization (DP). The DP of cellulose is dependent on its origin; thus, the DP of raw cotton can be up to 12 000. Cotton linters usually have a DP of from 800 to 1800 and in the case of wood pulp it is in the range from 600 to 1200. However, for many applications it is desirable to use cellulose having a DP which is lower than the values given above and it is also desirable to reduce the proportion of polymers having a long chain length.

Various methods of degrading cellulose are known; these can be divided into four groups: mechanical degradation, thermal degradation, degradation by action of radiation and chemical degradation (D. Klemm et al., Comprehensive Cellulose Chemistry, Vol. 1, pp. 83-127, Wiley Verlag, 1998).

In the case of mechanical degradation, for example dry or wet milling, it is a disadvantage that the DP of the cellulose is reduced to only a small extent. In the case of thermal treatment, uncontrolled degradation takes place and, in addition, the cellulose is modified; in particular, dehydrocelluloses can be formed. In the case of degradation by means of radiation, cellulose can be treated with high-energy radiation, for example X-rays. Here, the DP of the cellulose is reduced very rapidly. However, chemical modification of the cellulose also occurs, with a large number of carboxylic acid or keto functions being formed. On the other hand, if radiation having lower energy, for example UV/visible light, is used, it is necessary to use photosensitizers. Here too, modification of the cellulose occurs by formation of keto functions or, if oxygen is present during irradiation, peroxide formation occurs.

Known chemical degradation methods are acidic, alkaline and oxidative degradation and also enzymatic degradation.

In heterogeneous acidic degradation, the cellulose is, for example, suspended in dilute mineral acid and treated at elevated temperature. In this method, it is found that the DP of the cellulose obtained after work-up (degraded cellulose) does not drop below the “level-off DP” (LODP). The LODP appears to be related to the size of the crystalline regions of the cellulose used. It is dependent on the cellulose used and also on the reaction medium if, for example, solvents such as dimethyl sulfoxide, water, alcohols or methyl ethyl ketone are additionally added. In this method, the yield of degraded cellulose is low because the amorphous regions and the accessible regions of the cellulose are hydrolyzed completely.

Furthermore, it is also possible to subject cellulose to acidic degradation in a homogeneous system. Here, cellulose is, for example, dissolved in a mixture of LiCl/dimethylformamide and treated with an acid. In this method, the preparation of the solution is very costly, the work-up is complicated and the yield of degraded cellulose is low.

In the alkaline degradation of cellulose, glucose units are split off stepwise at the reducing end of the cellulose. This leads to low yields of degraded cellulose.

The oxidative degradation of cellulose is generally carried out by means of oxygen. It normally comprises the formation of individual anhydroglucose units as initial step, and these react further to form unstable intermediates and finally lead to chain rupture. The control of this reaction is generally difficult.

The abovementioned methods thus have various disadvantages and there is therefore a need to provide a process for the targeted degradation of cellulose which is effected without modification of the polymer and with high yields.

A process for the controlled degradation of cellulose which comprises dissolving cellulose in an ionic liquid and treating it with an acid, if appropriate with addition of water, has now been found.

For the purposes of the present invention, ionic liquids are preferably

### (A) Salts of the General Formula (I)

[A]ₙ⁺[Y]ⁿ⁻ (I),
where n is 1, 2, 3 or 4, [A]⁺ is a quaternary ammonium cation, an oxonium cation, a sulfonium cation or a phosphonium cation and [Y]ⁿ⁻ is a monovalent, divalent, trivalent or tetravalent anion;

### (B) Mixed Salts of the General Formulae (II)

[A¹]⁺[A²]⁺[Y]ⁿ⁻ (IIa), where n=2;

[A¹]⁺[A²]⁺[A³]⁺[Y]ⁿ⁻ (IIb), where n=3; or

[A¹]⁺[A²]⁺[A³]⁺[A⁴]⁺[Y]ⁿ⁻ (IIc), where n=4, and
[A¹]⁺, [A²]⁺, [A³]⁺ and [A⁴]+are selected independently from among the groups specified for [A]⁺ and [Y]ⁿ⁻ has the meaning given under (A).

The ionic liquids preferably have a melting point below 180° C. The melting point is particularly preferably in the range from −50° C. to 150° C., in particular in the range from −20° C. to 120° C. and extraordinarily preferably below 100° C.

Compounds which are suitable for forming the cation [A]⁺ of ionic liquids are known, for example, from DE 102 02 838 A1. Thus, such compounds can comprise oxygen, phosphorus, sulfur, or in particular nitrogen atoms, for example at least one nitrogen atom, preferably from 1 to 10 nitrogen atoms, particularly preferably from 1 to 5 nitrogen atoms, very particularly preferably from 1 to 3 nitrogen atoms and in particular 1 or 2 nitrogen atoms. If appropriate, further heteroatoms such as oxygen, sulfur or phosphorus atoms can also be comprised. The nitrogen atom is a suitable carrier of the positive charge in the cation of the ionic liquid from which a proton or an alkyl radical can then be transferred in equilibrium to the anion in order to produce an electrically neutral molecule.

If the nitrogen atom is the carrier of the positive charge in the cation of the ionic liquid, a cation can firstly be produced by quaternization of the nitrogen atom of, for instance, an amine or nitrogen heterocycle in the synthesis of the ionic liquids. Quaternization can be effected by alkylation of the nitrogen atom. Depending on the alkylating reagent used, salts having different anions are obtained. In cases in which it is not possible to form the desired anion in the quaternization, this can be effected in a further step of the synthesis. Starting from, for example, an ammonium halide, the halide can be reacted with a Lewis acid to form a complex anion from halide and Lewis acid. A possible alternative thereto is replacement of a halide ion by the desired anion. This can be achieved by addition of a metal salt to precipitate the metal halide formed, by means of an ion exchanger or by displacement of the halide ion by a strong acid (with liberation of the hydrogen halide). Suitable processes are, for example, described in Angew. Chem. 2000, 112, pp. 3926-3945, and the references cited therein.

Suitable alkyl radicals by means of which the nitrogen atom in the amines or nitrogen heterocycles can, for example, be quaternized are C₁-C₁₈-alkyl, preferably C₁-C₁₀-alkyl, particularly preferably C₁-C₆-alkyl and very particularly preferably methyl. The alkyl group can be unsubstituted or have one or more identical or different substituents.

Preference is given to compounds which comprise at least one five- or six-membered heterocycle, in particular a five-membered heterocycle, which has at least one nitrogen atom and also, if appropriate, an oxygen or sulfur atom. Particular preference is likewise given to compounds which comprise at least one five- or six-membered heterocycle which has one, two or three nitrogen atoms and a sulfur atom or an oxygen atom, very particularly preferably ones having two nitrogen atoms. Further preference is given to aromatic heterocycles.

Particularly preferred compounds are ones which have a molecular weight of less than 1000 g/mol, very particularly preferably less than 500 g/mol and in particular less than 350 g/mol.

Furthermore, preference is given to cations selected from among the compounds of the formulae (IIIa) to (IIIw),

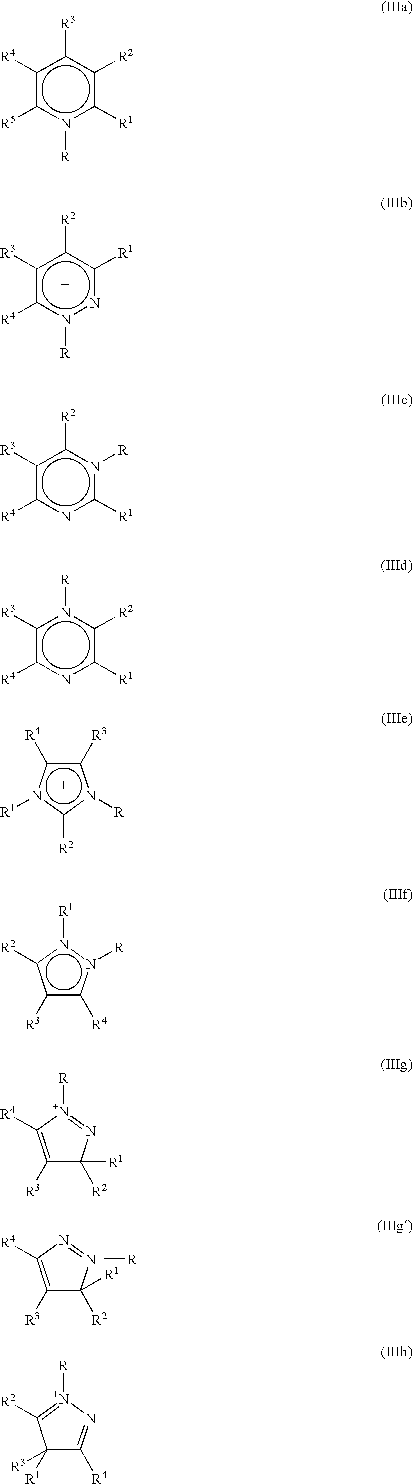

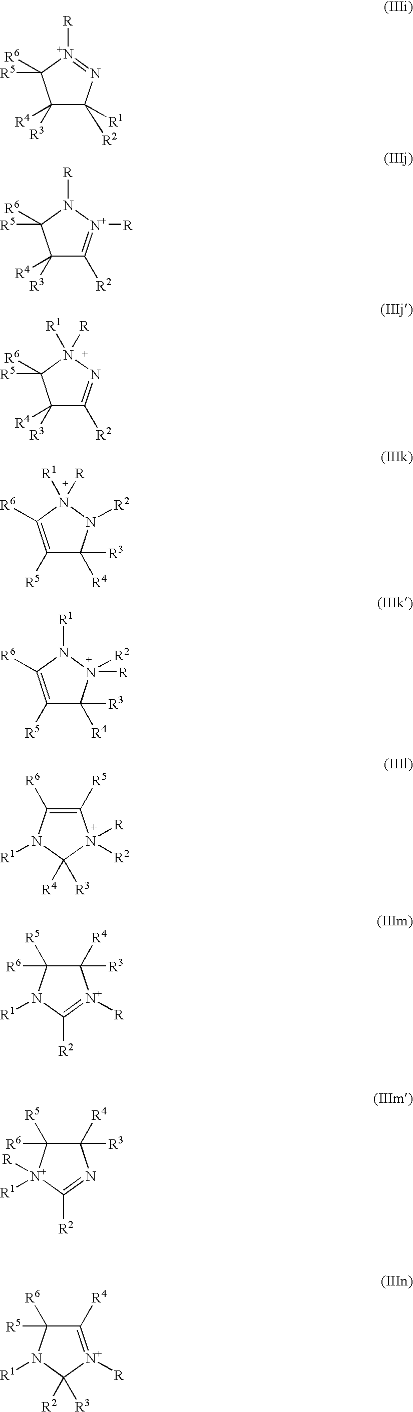

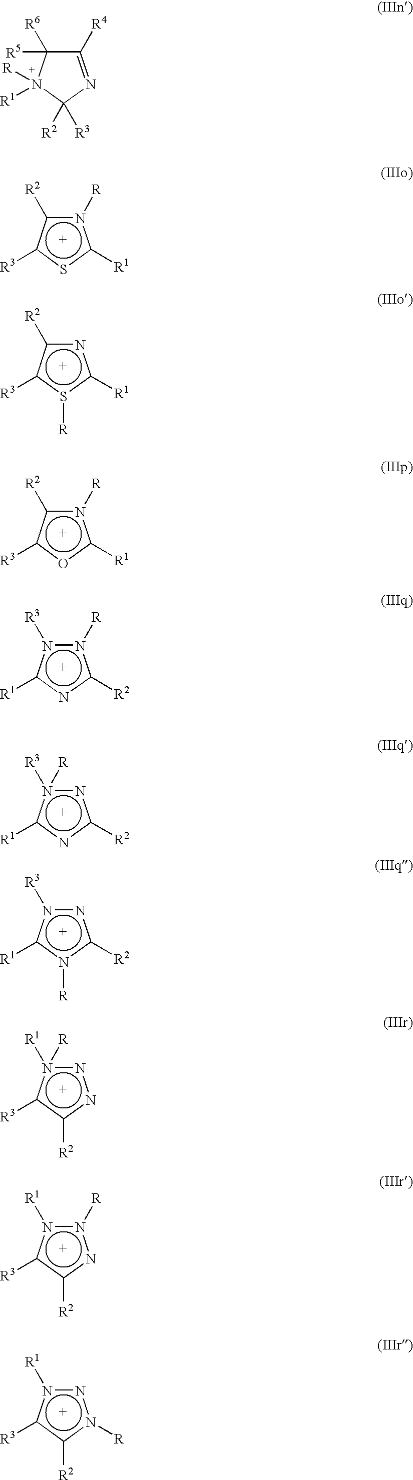

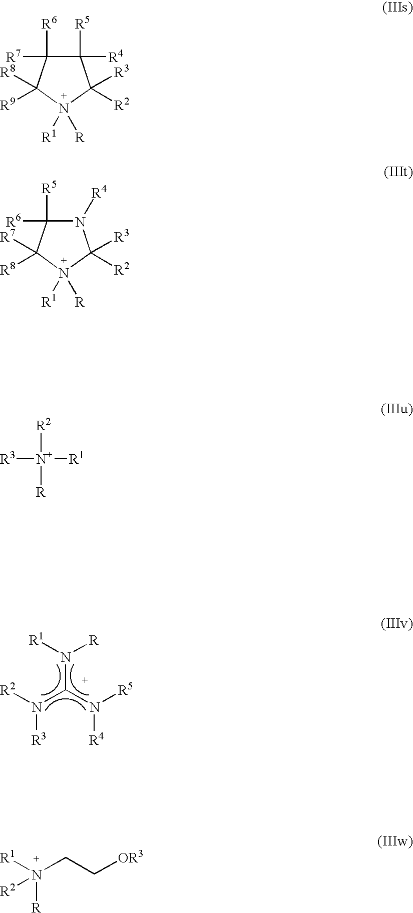

and oligomers comprising these structures.

Further suitable cations are compounds of the general formulae (IIIx) and (IIIy)

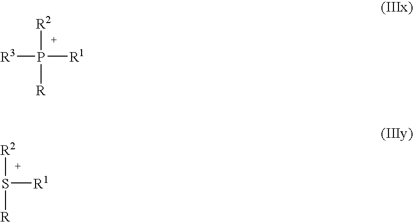

and also oligomers comprising these structures.

In the above formulae (IIIa) to (IIIy),
the radical R is hydrogen or a carbon-comprising organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or functional groups; and
the radicals R¹ to R⁹ are each, independently of one another, hydrogen, a sulfo group or a carbon-comprising organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or functional groups, where the radicals R¹ to R⁹ which are bound to a carbon atom (and not to a heteroatom) in the abovementioned formulae (III) can additionally be halogen or a functional group; or
two adjacent radicals from the group consisting of R¹ to R⁹ may together also form a divalent, carbon-comprising organic, saturated or unsaturated, acyclic or cyclic, aliphatic, aromatic or araliphatic radical which has from 1 to 30 carbon atoms and may be unsubstituted or be interrupted or substituted by from 1 to 5 heteroatoms or functional groups.

In the definitions of the radicals R and R¹ to R⁹, possible heteroatoms are in principle all heteroatoms which are able to formally replace a —CH₂— group, a —CH═ group, a —C≡ group or a ═C═ group. If the carbon-comprising radical comprises heteroatoms, then oxygen, nitrogen, sulfur, phosphorus and silicon are preferred. Preferred groups are, in particular, —O—, —S—, —SO—, —SO₂—, —NR′—, —N═, —PR′, —PR′₃ and —SiR′₂—, where the radicals R′ are the remaining part of the carbon-comprising radical. In the cases in which the radicals R¹ to R⁹ are bound to a carbon atom (and not a heteroatom) in the abovementioned formula (I), they can also be bound directly via the heteroatom.

Suitable functional groups are in principle all functional groups which can be bound to a carbon atom or a heteroatom. Suitable examples are —OH (hydroxy), ═O (in particular as carbonyl group), —NH₂ (amino), —NHR′, —NHR₂′, ═NH (imino), NR′ (imino), —COOH (carboxy), —CONH₂ (carboxamide), —SO₃H (sulfo) and —CN (cyano). Functional groups and heteroatoms can also be directly adjacent, so that combinations of a plurality of adjacent atoms, for instance —O-(ether), —S-(thioether), —COO-(ester), —CONH-(secondary amide) or —CONR′-(tertiary amide), are also comprised, for example di-(C₁-C₄-alkyl)amino, C₁-C₄-alkyloxycarbonyl or C₁-C₄-alkyloxy. The radicals R′ are the remaining part of the carbon-comprising radical.

As halogens, mention may be made of fluorine, chlorine, bromine and iodine.

The radical R is preferably
unbranched or branched C₁-C₁₈-alkyl which may be unsubstituted or substituted by one or more hydroxy, halogen, phenyl, cyano, C₁-C₆-alkoxycarbonyl and/or SO₃H and has a total of from 1 to 20 carbon atoms, for example methyl, ethyl, 1-propyl, 2-propyl, 1-butyl, 2-butyl, 2-methyl-1-propyl, 2-methyl-2-propyl, 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, 1-heptyl, 1-octyl, 1-nonyl, 1-decyl, 1-undecyl, 1-dodecyl, 1-tetradecyl, 1-hexadecyl, 1-octadecyl, 2-hydroxyethyl, benzyl, 3-phenylpropyl, 2-cyanoethyl, 2-(methoxycarbonyl)ethyl, 2-(ethoxycarbonyl)ethyl, 2-(n-butoxycarbonyl)ethyl, trifluoromethyl, difluoromethyl, fluoromethyl, pentafluoroethyl, heptafluoropropyl, heptafluoroisopropyl, nonafluorobutyl, nonafluoroisobutyl, undecylfluoropentyl, undecylfluorisopentyl, 6-hydroxyhexyl and propylsulfonic acid;
glycols, butylene glycols and oligomers thereof having from 1 to 100 units and a hydrogen or a C₁-C₈-alkyl as end group, for example R^{A}O—(CHR^{B}—CH₂—O)ₘ—CHR^{B}—CH₂— or R^{A}O—(CH₂CH₂CH₂CH₂O)ₘ—CH₂CH₂CH₂CH₂O— where R^{A} and R^{B} are each preferably hydrogen, methyl or ethyl and m is preferably from 0 to 3, in particular 3-oxabutyl, 3-oxapentyl, 3,6-dioxaheptyl, 3,6-dioxaoctyl, 3,6,9-trioxadecyl, 3,6,9-trioxaundecyl, 3,6,9,12-tetraoxamidecyl and 3,6,9,12-tetraoxatetradecyl;
vinyl;
1-propen-1-yl, 1-propen-2-yl and 1-propen-3-yl; and
N,N-di-C₁-C₆-alkylamino such as N,N-dimethylamino and N,N-diethylamino.

The radical R is particularly preferably unbranched and unsubstituted C₁-C₁₈-alkyl, such as methyl, ethyl, 1-propyl, 1-butyl, 1-pentyl, 1-hexyl, 1-heptyl, 1-octyl, 1-decyl, 1-dodecyl, 1-tetradecyl, 1-hexadecyl, 1-octadecyl, 1-propen-3-yl, in particular methyl, ethyl, 1-butyl and 1-octyl or CH₃O—(CH₂CH₂O)ₘ—CH₂CH₂— and CH₃CH₂O—(CH₂CH₂O)ₘ—CH₂CH₂— where m is from 0 to 3.

Preference is given to the radicals R¹ to R⁹ each being, independently of one another,
hydrogen;
halogen;
a functional group;
a C₁-C₁₈-alkyl which may optionally be substituted by functional groups, aryl, alkyl, aryloxy, alkyloxy, halogen, heteroatoms and/or heterocycles and/or be interrupted by one or more oxygen and/or sulfur atoms and/or one or more substituted or unsubstituted imino groups;
C₂-C₁₈-alkenyl, which may optionally be substituted by functional groups, aryl, alkyl, aryloxy, alkyloxy, halogen, heteroatoms and/or heterocycles and/or be interrupted by one or more oxygen and/or sulfur atoms and/or one or more substituted or unsubstituted imino groups;
C₆-C₁₂-aryl which may optionally be substituted by functional groups, aryl, alkyl, aryloxy, alkyloxy, halogen, heteroatoms and/or heterocycles;
C₅-C₁₂-cycloalkyl which may optionally be substituted by functional groups, aryl, alkyl, aryloxy, alkyloxy, halogen, heteroatoms and/or heterocycles;
C₅-C₁₂-cycloalkenyl which may optionally be substituted by functional groups, aryl, alkyl, aryloxy, alkyloxy, halogen, heteroatoms and/or heterocycles; or
a five- or six-membered, oxygen-, nitrogen- and/or sulfur-comprising heterocycle which may optionally be substituted by functional groups, aryl, alkyl, aryloxy, alkyloxy, halogen, heteroatoms and/or heterocycles; or
   two adjacent radicals together form
an unsaturated, saturated or aromatic ring which may optionally be substituted by functional groups, aryl, alkyl, aryloxy, alkyloxy, halogen, heteroatoms and/or heterocycles and may optionally be interrupted by one or more oxygen and/or sulfur atoms and/or one or more substituted or unsubstituted imino groups.

C₁-C₁₈-alkyl which may optionally be substituted by functional groups, aryl, alkyl, aryloxy, alkyloxy, halogen, heteroatoms and/or heterocycles is preferably methyl, ethyl, 1-propyl, 2-propyl, 1-butyl, 2-butyl, 2-methyl-1-propyl (isobutyl), 2-methyl-2-propyl (tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, 2-ethylhexyl, 2,4,4-trimethylpentyl, 1,1,3,3-tetra-methylbutyl, 1-nonyl, 1-decyl, 1-undecyl, 1-dodecyl, 1-tridecyl, 1-tetradecyl, 1-pentadecyl, 1-hexadecyl, 1-heptadecyl, 1-octadecyl, cyclopentylmethyl, 2-cyclopentylethyl, 3-cyclopentylpropyl, cyclohexylmethyl, 2-cyclohexylethyl, 3-cyclohexylpropyl, benzyl (phenylmethyl), diphenylmethyl (benzhydryl), triphenylmethyl, 1-phenylethyl, 2-phenylethyl, 3-phenylpropyl, α,α-dimethylbenzyl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonyl-ethyl, 2-ethoxycarbonylethyl, 2-butoxycarbonylpropyl, 1,2-di-(methoxycarbonyl)ethyl, methoxy, ethoxy, formyl, 1,3-dioxolan-2-yl, 1,3-dioxan-2-yl, 2-methyl-1,3-dioxolan-2-yl, 4-methyl-1,3-dioxolan-2-yl, 2-hydroxyethyl, 2-hydroxypropyl, 3-hydroxypropyl, 4-hydroxybutyl, 6-hydroxyhexyl, 2-aminoethyl, 2-aminopropyl, 3-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl, 6-ethoxyhexyl, acetyl, CₘF_{2(m-a)+(1-b)}H_{2a+b} where m is from 1 to 30, 0≦a≦m and b=0 or 1 (for example CF₃, C₂F₅, CH₂CH₂—C₍ₘ₋₂₎F₂₍ₘ₋₂₎₊₁, C₆F₁₃, C₈F₁₇, C₁₀F₂₁, C₁₂F₂₅), chloromethyl, 2-chloroethyl, trichloromethyl, 1,1-dimethyl-2-chloroethyl, methoxymethyl, 2-butoxyethyl, diethoxymethyl, diethoxyethyl, 2-isopropoxyethyl, 2-butoxypropyl, 2-octyloxyethyl, 2-methoxyisopropyl, 2-(methoxycarbonyl)ethyl, 2-(ethoxycarbonyl)ethyl, 2-(n-butoxy-carbonyl)ethyl, butylthiomethyl, 2-dodecylthioethyl, 2-phenylthioethyl, 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-Hydroxy-5,10-dioxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-dioxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

C₂-C₁₈-Alkenyl which may optionally be substituted by functional groups, aryl, alkyl, aryloxy, alkyloxy, halogen, heteroatoms and/or heterocycles and/or be interrupted by one or more oxygen and/or sulfur atoms and/or one or more substituted or unsubstituted imino groups is preferably vinyl, 2-propenyl, 3-butenyl, cis-2-butenyl, trans-2-butenyl or CₘF_{2(m-a)-(1-b)}H_{2a-b} where m≦30, 0≦a≦m and b=0 or 1.

C₆-C₁₂-aryl which may optionally be substituted by functional groups, aryl, alkyl, aryloxy, alkyloxy, halogen, heteroatoms and/or heterocycles is preferably phenyl, tolyl, xylyl, α-naphthyl, β-naphthyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2-nitrophenyl, 4-nitrophenyl, 2,4-dinitrophenyl, 2,6-dinitrophenyl, 4-dimethylaminophenyl, 4-acetylphenyl, methoxyethylphenyl, ethoxymethylphenyl, methylthiophenyl, isopropylthiophenyl or tert-butylthiophenyl or C₆F₍₅₋ₐ₎H, where 0≦a≦5.

C₅-C₁₂-cycloalkyl which may optionally be substituted by functional groups, aryl, alkyl, aryloxy, alkyloxy, halogen, heteroatoms and/or heterocycles is preferably cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl, CₘF_{2(m-a)-(1-b)}H_{2a-b} where m≦30, 0≦a≦m and b=0 or 1, or a saturated or unsaturated bicyclic system such as norbornyl or norbornenyl.

C₅- to C₁₂-cycloalkenyl which may optionally be substituted by functional groups, aryl, alkyl, aryloxy, alkyloxy, halogen, heteroatoms and/or heterocycles is preferably 3-cyclopentenyl, 2-cyclohexenyl, 3-cyclohexenyl, 2,5-cyclohexadienyl or CₙF_{2(m-a)-3(1-b)}H_{2a-3b} where m≦30, 0≦a≦m and b=0 or 1.

A five- or six-membered, oxygen-, nitrogen- and/or sulfur-comprising heterocycle which may optionally be substituted by functional groups, aryl, alkyl, aryloxy, alkyloxy, halogen, heteroatoms and/or heterocycles is preferably furyl, thiophenyl, pyrryl, pyridyl, indolyl, benzoxazolyl, dioxolyl, dioxyl, benzimidazolyl, benzthiazolyl, dimethylpyridyl, methylquinolyl, dimethylpyrryl, methoxyfuryl, dimethoxypyridyl or difluoropyridyl.

If two adjacent radicals together form an unsaturated, saturated or aromatic ring which may optionally be substituted by functional groups, aryl, alkyl, aryloxy, alkyloxy, halogen, heteroatoms and/or heterocycles and may optionally be interrupted by one or more oxygen and/or sulfur atoms and/or one or more substituted or unsubstituted imino groups, they preferably form 1,3-propylene, 1,4-butylene, 1,5-pentylene, 2-oxa-1,3-propylene, 1-oxa-1,3-propylene, 2-oxa-1,3-propylene, 1-oxa-1,3-propenylene, 3-oxa-1,5-pentylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene.

If the abovementioned radicals comprise oxygen and/or sulfur atoms and/or substituted or unsubstituted imino groups, the number of oxygen and/or sulfur atoms and/or imino groups is not subject to any restrictions. In general, there will be no more than 5 in the radical, preferably no more than 4 and very particularly preferably no more than 3.

If the abovementioned radicals comprise heteroatoms, there is generally at least one carbon atom, preferably at least two carbon atoms, between any two heteroatoms.

Particular preference is given to the radicals R¹ to R⁹ each being, independently of one another,
hydrogen;
unbranched or branched C₁-C₁₈-alkyl which may be unsubstituted or substituted by one or more hydroxy, halogen, phenyl, cyano, C₁-C₆-alkylcarbonyl and/or SO₃H and has a total of from 1 to 20 carbon atoms, for example methyl, ethyl, 1-propyl, 2-propyl, 1-butyl, 2-butyl, 2-methyl-1-propyl, 2-methyl-2-propyl, 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, 1-heptyl, 1-octyl, 1-nonyl, 1-decyl, 1-undecyl, 1-dodecyl, 1-tetradecyl, 1-hexadecyl, 1-octadecyl, 2-hydroxyethyl, benzyl, 3-phenylpropyl, 2-cyanoethyl, 2-(methoxycarbonyl)ethyl, 2-(ethoxycarbonyl)ethyl, 2-(n-butoxy-carbonyl)ethyl, trifluoromethyl, difluoromethyl, fluoromethyl, pentafluoroethyl, heptafluoropropyl, heptafluoroisopropyl, nonafluorobutyl, nonafluoroisobutyl, undecylfluoropentyl, undecylfluoroisopentyl, 6-hydroxyhexyl and propylsulfonic acid;
glycols, butylene glycols and oligomers thereof having from 1 to 100 units and a hydrogen or a C₁-C₈-alkyl as end group, for example R^{A}O—(CHR^{B}—CH₂—O)ₘ—CHR^{B}—CH₂— or R^{A}O—(CH₂CH₂CH₂CH₂O)ₘ—CH₂CH₂CH₂CH₂— where R^{A} and R^{B} are each preferably hydrogen, methyl or ethyl and n is preferably from 0 to 3, in particular 3-oxabutyl, 3-oxapentyl, 3,6-dioxaheptyl, 3,6-dioxaoctyl, 3,6,9-trioxadecyl, 3,6,9-trioxaundecyl, 3,6,9,12-tetraoxamidecyl and 3,6,9,12-tetraoxatetradecyl;
vinyl;
1-propen-1-yl, 1-propen-2-yl and 1-propen-3-yl; and
N,N-di-C₁-C₆-alkylamino, such as N,N-dimethylamino and N,N-diethylamino.

Very particular preference is given to the radicals R¹ to R⁹ each being, independently of one another, hydrogen or C₁-C₁₈-alkyl such as methyl, ethyl, 1-butyl, 1-pentyl, 1-hexyl, 1-heptyl, 1-octyl, phenyl, 2-hydroxyethyl, 2-cyanoethyl, 2-(methoxy-carbonyl)ethyl, 2-(ethoxycarbonyl)ethyl, 2-(n-butoxycarbonyl)ethyl, N,N-dimethylamino, N,N-diethylamino, chlorine or CH₃O—(CH₂CH₂O)ₘ—CH₂CH₂— and CH₃CH₂O—(CH₂CH₂O)ₘ—CH₂CH₂— where m is from 0 to 3.

Very particularly preferred pyridinium ions (IIIa) are those in which
one of the radicals R¹ to R⁵ is methyl, ethyl or chlorine and the remaining radicals R¹ to R⁵ are each hydrogen;
a R³ is dimethylamino and the remaining radicals R¹, R², R⁴ and R⁵ are each hydrogen;
all radicals R¹ to R⁵ are hydrogen;
R² is carboxy or carboxamide and the remaining radicals R¹, R², R⁴ and R⁵ are each hydrogen; or
R¹ and R² or R² and R³ are together 1,4-buta-1,3-dienylene and the remaining radicals R¹, R², R⁴ and R⁵ are each hydrogen;
   and in particular those in which
R¹ to R⁵ are each hydrogen; or
one of the radicals R¹ to R⁵ is methyl or ethyl and the remaining radicals R¹ to R⁵ are each hydrogen.

As very particularly preferred pyridinium ions (IIIa), mention may be made of 1-methylpyridinium, 1-ethylpyridinium, 1-(1-butyl)pyridinium, 1-(1-hexyl)pyridinium, 1-(1-octyl)pyridinium, 1-(1-hexyl)pyridinium, 1-(1-octyl)pyridinium, 1-(1-dodecyl)pyridinium, 1-(1-tetradecyl)pyridinium, 1-(1-hexadecyl)pyridinium, 1,2-di-methylpyridinium, 1-ethyl-2-methylpyridinium, 1-(1-butyl)-2-methylpyridinium, 1-(1-hexyl)-2-methylpyridinium, 1-(1-octyl)-2-methylpyridinium, 1-(1-dodecyl)-2-methylpyridinium, 1-(1-tetradecyl)-2-methylpyridinium, 1-(1-hexadecyl)-2-methylpyridinium, 1-methyl-2-ethylpyridinium, 1,2-diethylpyridinium, 1-(1-butyl)-2-ethylpyridinium, 1-(1-hexyl)-2-ethylpyridinium, 1-(1-octyl)-2-ethylpyridinium, 1-(1-dodecyl)-2-ethylpyridinium, 1-(1-tetradecyl)-2-ethylpyridinium, 1-(1-hexadecyl)-2-ethylpyridinium, 1,2-dimethyl-5-ethylpyridinium, 1,5-diethyl-2-methylpyridinium, 1-(1-butyl)-2-methyl-3-ethylpyridinium, 1-(1-hexyl)-2-methyl-3-ethylpyridinium and 1-(1-octyl)-2-methyl-3-ethyl-pyridinium, 1-(1-dodecyl)-2-methyl-3-ethylpyridinium, 1-(1-tetradecyl)-2-methyl-3-ethylpyridinium and 1-(1-hexadecyl)-2-methyl-3-ethyl-pyridinium.

Very particularly preferred pyridazinium ions (IIIb) are those in which
R¹ to R⁴ are each hydrogen; or
one of the radicals R¹ to R⁴ is methyl or ethyl and the remaining radicals R¹ to R⁴ are each hydrogen.

Very particularly preferred pyrimidinium ions (IIIc) are those in which
R¹ is hydrogen, methyl or ethyl and R² to R⁴ are each, independently of one another, hydrogen or methyl; or
R¹ is hydrogen, methyl or ethyl, R² and R⁴ are each methyl and R³ is hydrogen.

Very particularly preferred pyrazinium ions (IIId) are those in which
R¹ is hydrogen, methyl or ethyl and R² to R⁴ are each, independently of one another, hydrogen or methyl;
R¹ is hydrogen, methyl or ethyl, R² and R⁴ are each methyl and R³ is hydrogen;
R¹ to R⁴ are each methyl; or
R¹ to R⁴ are each methyl or hydrogen.

Very particularly preferred imidazolium ions (IIIe) are those in which
R¹ is hydrogen, methyl, ethyl, 1-propyl, 1-butyl, 1-pentyl, 1-hexyl, 1-octyl, 1-propen-3-yl, 2-hydroxyethyl or 2-cyanoethyl and R² to R⁴ are each, independently of one another, hydrogen, methyl or ethyl.

As very particularly preferred imidazolium ions (Ille), mention may be made of 1-methylimidazolium, 1-ethylimidazolium, 1-(1-butyl)imidazolium, 1-(1-octyl)imidazolium, 1-(1-dodecyl)imidazolium, 1-(1-tetradecyl)imidazolium, 1-(1-hexadecyl)imidazolium, 1,3-dimethylimidazolium, 1-ethyl-3-methylimidazolium, 1-(1-butyl)-3-methylimidazolium, 1-(1-butyl)-3-ethylimidazolium, 1-(1-hexyl)-3-methyl-imidazolium, 1-(1-hexyl)-3-ethylimidazolium, 1-(1-hexyl)-3-butylimidazolium, 1-(1-octyl)-3-methylimidazolium, 1-(1-octyl)-3-ethylimidazolium, 1-(1-octyl)-3-butyl-imidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-tetradecyl)-3-butyl-imidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethylimidazolium, 3-butylimidazolium, 1,4-dimethyl-3-octylimidazolium, 1,4,5-trimethylimidazolium, 1,3,4,5-tetramethyl-imidazolium, 1,4,5-trimethyl-3-ethylimidazolium, 1,4,5-trimethyl-3-butylimidazolium, 1,4,5-trimethyl-3-octylimidazolium, and 1-(prop-1-en-3-yl)-3-methylimidazolium.

Very particularly preferred pyrazolium ions (IIIf), (IIIg) and (IIIg′) are those in which
R¹ is hydrogen, methyl or ethyl and R² to R⁴ are each, independently of one another, hydrogen or methyl.

Very particularly preferred pyrazolium ions (IIIh) are those in which
R¹ to R⁴ are each, independently of one another, hydrogen or methyl.

Very particularly preferred 1-pyrazolinium ions (IIIi) are those in which
R¹ to R⁶ are each, independently of one another, hydrogen or methyl.

Very particularly preferred 2-pyrazolinium ions (IIIj) and (IIIj′) are those in which
R¹ is hydrogen, methyl, ethyl or phenyl and R² to R⁶ are each, independently of one another, hydrogen or methyl.

Very particularly preferred 3-pyrazolinium ions (IIIk) and (IIIk′) are those in which
R¹ and R² are each, independently of one another, hydrogen, methyl, ethyl or phenyl and R³ to R⁶ are each, independently of one another, hydrogen or methyl.

Very particularly preferred imidazolinium ions (IIIl) are those in which
R¹ and R² are each, independently of one another, hydrogen, methyl, ethyl, 1-butyl or phenyl, R³ and R⁴ are each, independently of one another, hydrogen, methyl or ethyl and R⁵ and R⁶ are each, independently of one another, hydrogen or methyl.

Very particularly preferred imidazolinium ions (IIIm) and (IIIm′) are those in which
R¹ and R² are each, independently of one another, hydrogen, methyl or ethyl and R³ to R⁶ are each, independently of one another, hydrogen or methyl.

Very particularly preferred imidazolinium ions (IIIn) and (IIIn′) are those in which
R¹ to R³ are each, independently of one another, hydrogen, methyl or ethyl and R⁴ to R⁶ are each, independently of one another, hydrogen or methyl.

Very particularly preferred thiazolium ions (IIIo) and (IIIo′) and oxazolium ions (IIIp) are those in which
R¹ is hydrogen, methyl, ethyl or phenyl and R² and R³ are each, independently of one another, hydrogen or methyl.

Very particularly preferred 1,2,4-triazolium ions (IIIq), (IIIq′) and (IIIq″) are those in which
R¹ and R² are each, independently of one another, hydrogen, methyl, ethyl or phenyl and R³ is hydrogen, methyl or phenyl.

Very particularly preferred 1,2,3-triazolium ions (IIIr), (IIIr′) and (IIIr″) are those in which
R¹ is hydrogen, methyl or ethyl and R² and R³ are each, independently of one another, hydrogen or methyl or R² and R³ are together 1,4-buta-1,3-dienylene.

Very particularly preferred pyrrolidinium ions (Ills) are those in which
R¹ is hydrogen, methyl, ethyl or phenyl and R² to R⁹ are each, independently of one another, hydrogen or methyl.

Very particularly preferred imidazolidinium ions (IIIt) are those in which
R¹ and R⁴ are each, independently of one another, hydrogen, methyl, ethyl or phenyl and R² and R³ and also R⁵ to R⁸ are each, independently of one another, hydrogen or methyl.

Very particularly preferred ammonium ions (IIIu) are those in which
R¹ to R³ are each, independently of one another, C₁-C₁₈-alkyl; or
R¹ and R² are together 1,5-pentylene or 3-oxa-1,5-pentylene and R³ is C₁-C₁₈-alkyl, 2-hydroxyethyl or 2-cyanoethyl.

Very particularly preferred ammonium ions (IIIu) are methyltri(1-butyl)ammonium, N,N-dimethylpiperidinium and N,N-dimethylmorpholinium.

Examples of tertiary amines from which the quaternary ammonium ions of the general formula (IIIu) can be derived by quaternization by the abovementioned radicals R are diethyl-n-butylamine, diethyl-tert-butylamine, diethyl-n-pentylamine, diethyl-hexylamine, diethyloctylamine, diethyl-(2-ethylhexyl)amine, di-n-propylbutylamine, di-n-propyl-n-pentylamine, di-n-propylhexylamine, di-n-propyloctylamine, di-n-propyl-(2-ethylhexyl)amine, diisopropylethylamine, diiso-propyl-n-propylamine, diisopropylbutylamine, diisopropylpentylamine, diiso-propylhexylamine, diisopropyloctylamine, diisopropyl(2-ethylhexyl)amine, di-n-butylethylamine, di-n-butyl-n-propylamine, di-n-butyl-n-pentylamine, di-n-butylhexylamine, di-n-butyloctylamine, di-n-butyl(2-ethylhexyl)amine, N-n-butyl-pyrrolidine, N-sec-butylpyrrolidine, N-tert-butylpyrrolidine, N-n-pentylpyrrolidine, N,N-dimethylcyclohexylamine, N,N-diethylcyclohexylamine, N,N-di-n-butylcyclo-hexylamine, N-n-propylpiperidine, N-isopropylpiperidine, N-n-butylpiperidine, N-sec-butylpiperidine, N-tert-butylpiperidine, N-n-pentylpiperidine, N-n-butylmorpholine, N-sec-butylmorpholine, N-tert-butylmorpholine, N-n-pentylmorpholine, N-benzyl-N-ethylaniline, N-benzyl-N-n-propylaniline, N-benzyl-N-isopropylaniline, N-benzyl-N-n-butylaniline, N,N-dimethyl-p-toluidine, N,N-diethyl-p-toluidine, N,N-di-n-butyl-p-toluidine, diethylbenzylamine, di-n-propylbenzylamine, di-n-butylbenzylamine, diethylphenylamine, di-n-propylphenylamine and di-n-butylphenylamine.

Preferred tertiary amines (IIIu) are diisopropylethylamine, diethyl-tert-butylamine, di-isopropylbutylamine, di-n-butyl-n-pentylamine, N,N-di-n-butylcyclohexylamine and also tertiary amines derived from pentyl isomers.

Particularly preferred tertiary amines are di-n-butyl-n-pentylamine and tertiary amines derived from pentyl isomers. A further preferred tertiary amine having three identical radicals is triallylamine.

Very particularly preferred guanidinium ions (IIIv) are those in which
R¹ to R⁵ are each methyl.

A very particularly preferred guanidinium ion (IIIv) is N,N,N′,N′,N″,N″-hexamethylguanidinium.

Very particularly preferred cholinium ions (IIIw) are those in which
R¹ and R² are each, independently of one another, methyl, ethyl, 1-butyl or 1-octyl and R³ is hydrogen, methyl, ethyl, acetyl, —SO₂OH or —PO(OH)₂;
R¹ is methyl, ethyl, 1-butyl or 1-octyl, R² is a —CH₂—CH₂—OR⁴ group and R³ and R⁴ are each, independently of one another, hydrogen, methyl, ethyl, acetyl, —SO₂OH or —PO(OH)₂; or
R¹ is a —CH₂—CH₂—OR⁴ group, R² is a —CH₂—CH₂—OR⁵ group and R³ to R⁵ are each, independently of one another, hydrogen, methyl, ethyl, acetyl, —SO₂OH or —PO(OH)₂.

Particularly preferred cholinium ions (IIIw) are those in which R³ is selected from among hydrogen, methyl, ethyl, acetyl, 5-methoxy-3-oxapentyl, 8-methoxy-3,6-dioxa-octyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8, 12-trioxapentadecyl, 9-ethoxy-5-oxanonyl or 14-ethoxy-5,10-oxa-tetradecyl.

Very particularly preferred phosphonium ions (IIIx) are those in which
R¹ to R³ are each, independently of one another, C₁-C₁₈-alkyl, in particular butyl, isobutyl, 1-hexyl or 1-octyl.

Among the abovementioned heterocyclic cations, preference is given to the pyridinium ions, pyrazolinium ions, pyrazolium ions and the imidazolinium ions and the imidazolium ions. Preference is also given to ammonium ions.

Particular preference is given to 1-methylpyridinium, 1-ethylpyridinium, 1-(1-butyl)-pyridinium, 1-(1-hexyl)pyridinium, 1-(1-octyl)pyridinium, 1-(1-hexyl)pyridinium, 1-(1-octyl)pyridinium, 1-(1-dodecyl)pyridinium, 1-(1-tetradecyl)pyridinium, 1-(1-hexa-decyl)pyridinium, 1,2-dimethylpyridinium, 1-ethyl-2-methylpyridinium, 1-(1-butyl)-2-methylpyridinium, 1-(1-hexyl)-2-methylpyridinium, 1-(1-octyl)-2-methylpyridinium, 1-(1-dodecyl)-2-methylpyridinium, 1-(1-tetradecyl)-2-methylpyridinium, 1-(1-hexadecyl)-2-methylpyridinium, 1-methyl-2-ethylpyridinium, 1,2-diethylpyridinium, 1-(1-butyl)-2-ethylpyridinium, 1-(1-hexyl)-2-ethylpyridinium, 1-(1-octyl)-2-ethylpyridinium, 1-(1-dodecyl)-2-ethylpyridinium, 1-(1-tetradecyl)-2-ethylpyridinium, 1-(1-hexadecyl)-2-ethyl pyridinium, 1,2-dimethyl-5-ethylpyridinium, 1,5-diethyl-2-methylpyridinium, 1-(1-butyl)-2-methyl-3-ethylpyridinium, 1-(1-hexyl)-2-methyl-3-ethylpyridinium, 1-(1-octyl)-2-methyl-3-ethylpyridinium, 1-(1-dodecyl)-2-methyl-3-ethylpyridinium, 1-(1-tetra-decyl)-2-methyl-3-ethylpyridinium, 1-(1-hexadecyl)-2-methyl-3-ethylpyridinium, 1-methylimidazolium, 1-ethylimidazolium, 1-(1-butyl)-imidazolium, 1-(1-octyl)-imidazolium, 1-(1-dodecyl)-imidazolium, 1-(1-tetradecyl)imidazolium, 1-(1-hexadecyl)imidazolium, 1,3-dimethylimidazolium, 1-ethyl-3-methylimidazolium, 1-(1-butyl)-3-methylimidazolium, 1-(1-hexyl)-3-methylimidazolium, 1-(1-octyl)-3-methylimidazolium, 1-(1-dodecyl)-3-methylimidazolium, 1-(1-tetradecyl)-3-methylimidazolium, 1-(1-hexadecyl)-3-methylimidazolium, 1,2-dimethylimidazolium, 1,2,3-trimethylimidazolium, 1-ethyl-2,3-dimethylimidazolium, 1-(1-butyl)-2,3-dimethyl-imidazolium, 1-(1-hexyl)-2,3-dimethylimidazolium and 1-(1-octyl)-2,3-dimethyl-imidazolium, 1,4-dimethylimidazolium, 1,3,4-trimethylimidazolium, 1,4-dimethyl-3-ethylimidazolium, 3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium and 1-(prop-1-en-3-yl)-3-methylimidazolium.

As anions, it is in principle possible to use all anions.

The anion [Y]ⁿ⁻ of the ionic liquid is, for example, selected from among
the group of halides and halogen-comprising compounds of the formulae: F—, Cl—, Br—, I—, BF₄—, PF₆—, CF₃SO₃—, (CF₃SO₃)₂N—, CF₃CO₂—, CCl₃CO₂—, CN—, SCN—, OCN—
the group of sulfates, sulfites and sulfonates of the general formulae: SO₄²—, HSO₄—, SO₃²—, HSO₃—, R^{a}OSO₃—, R^{a}SO₃—
the group of phosphates of the general formulae PO₄³—, HPO₄²—, H₂PO₄—, R^{a}PO₄²—, HR^{a}PO₄—, R^{a}R^{b}PO₄—
the group of phosphonates and phosphinates of the general formulae: R^{a}HPO₃—, R^{a}R^{b}PO₂—, R^{a}R^{b}PO₃—
the group of phosphites of the general formulae: PO₃³—, HPO₃²—, H₂PO₃—, R^{a}PO₃²—, R^{a}HPO₃—, R^{a}R^{b}PO₃—
the group of phosphonites and phosphinites of the general formulae: R^{a}R^{b}PO₂—, R^{a}HPO₂—, R^{a}R^{b}PO—, R^{a}HPO—
the group of carboxylic acids of the general formula: R^{a}COO—
the group of borates of the general formulae: BO₃³—, HBO₃—, H₂BO₃—, R^{a}R^{b}BO₃—, R^{a}HBO₃—, R^{a}BO₃²—, B(OR^{a})(OR^{b})(OR^{c})(OR^{d})—, B(HSO₄)—, B(R^{a}SO₄)—
the group of boronates of the general formulae: R^{a}BO₂²—, R^{a}R^{b}BO—
the group of silicates and silicic esters of the general formulae: SiO₄⁴—, HSiO₄³—, H₂SiO₄²—, H₃SiO₄—, R^{a}SiO₄³—, R^{a}R^{b}SiO₄²—, R^{a}R^{b}R^{c}SiO₄—, HR^{a}SiO₄²—, H₂R^{a}SiO₄—, HR^{a}R^{b}SiO₄—
the group of alkylsilane and arylsilane salts of the general formulae: R^{a}SiO₃³—, R^{a}R^{b}SiO₂²—, R^{a}R^{b}R^{c}SiO—, R^{a}R^{b}R^{c}SiO₃—, R^{a}R^{b}R^{c}SiO₂—, R^{a}R^{b}SiO₃²—
the group of carboximides, bis(sulfonyl)imides and sulfonylimides of the general formulae:

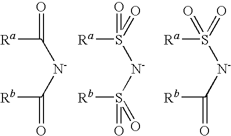

the group of methides of the general formula:

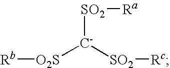

here, R^{a}, R^{b}, R^{c} and R^{d} are each, independently of one another, hydrogen, C₁-C₃₀-alkyl, C₂-C₁₈-alkyl which may optionally be interrupted by one or more nonadjacent oxygen and/or sulfur atoms and/or one or more substituted or unsubstituted imino groups, C₆-C₁₄-aryl, C₅-C₁₂-cycloalkyl or a five- or six-membered, oxygen-, nitrogen- and/or sulfur-comprising heterocycle, where two of them may together form an unsaturated, saturated or aromatic ring which may optionally be interrupted by one or more oxygen and/or sulfur atoms and/or one or more unsubstituted or substituted imino groups, where the radicals mentioned may each be additionally substituted by functional groups, aryl, alkyl, aryloxy, alkyloxy, halogen, heteroatoms and/or heterocycles.

Here, C₁-C₁₈-alkyl which may optionally be substituted by functional groups, aryl, alkyl, aryloxy, alkyloxy, halogen, heteroatoms and/or heterocycles is, for example, methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, hetadecyl, octadecyl, 1,1-dimethylpropyl, 1,1-dimethylbutyl, 1,1,3,3-tetramethylbutyl, benzyl, 1-phenylethyl, α,α-dimethylbenzyl, benzhydryl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonethyl, 2-ethoxycarbonylethyl, 2-butoxycarbonylpropyl, 1,2-di-(methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxo-Ian-2-yl, 4-methyl-1,3-dioxolan-2-yl, 2-isopropoxyethyl, 2-butoxypropyl, 2-octyl-oxyethyl, chloromethyl, trichloromethyl, trifluoromethyl, 1,1-dimethyl-2-chloroethyl, 2-methoxyisopropyl, 2-ethoxyethyl, butylthiomethyl, 2-dodecylthioethyl, 2-phenyl-thioethyl, 2,2,2-trifluoroethyl, 2-hydroxyethyl, 2-hydroxypropyl, 3-hydroxypropyl, 4-hydroxybutyl, 6-hydroxyhexyl, 2-aminoethyl, 2-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxyethyl, 2-methoxy-propyl, 3-methoxypropyl, 4-methoxybutyl, 6-methoxyhexyl, 2-ethoxyethyl, 2-ethoxypropyl, 3-ethoxypropyl, 4-ethoxybutyl or 6-ethoxyhexyl.

C₂-C₁₈-Alkyl which may optionally be interrupted by one or more nonadjacent oxygen and/or sulfur atoms and/or one or more substituted or unsubstituted imino groups is, for example, 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-oxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxa-pentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

If two radicals form a ring, these radicals can together form as fused-on building block, for example, 1,3-propylene, 1,4-butylene, 2-oxa-1,3-propylene, 1-oxa-1,3-propylene, 2-oxa-1,3-propenylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene.

The number of nonadjacent oxygen and/or sulfur atoms and/or imino groups is in principle not subject to any restrictions or is automatically restricted by the size of the radical or the cyclic building block. In general, there will be no more than 5 in the respective radical, preferably no more than 4 and very particularly preferably no more than 3. Furthermore, there is generally at least one carbon atom, preferably at least two carbon atoms, between any two heteroatoms.

Substituted and unsubstituted imino groups can be, for example, imino, methylimino, isopropylimino, n-butylimino or tert-butylimino.

For the purposes of the present invention, the term “functional groups” refers, for example, to the following: carboxy, carboxamide, hydroxy, di-(C₁-C₄-alkyl)amino, C₁-C₄-alkyloxycarbonyl, cyano or C₁-C₄-alkoxy. Here, C₁ to C₄-alkyl is methyl, ethyl, propyl, isopropyl, n-butyl, sec-butyl or tert-butyl.

C₆-C₁₄-Aryl which may optionally be substituted by functional groups, aryl, alkyl, aryloxy, alkyloxy, halogen, heteroatoms and/or heterocycles is, for example, phenyl, tolyl, xylyl, α-naphthyl, β-naphthyl, 4-diphenylyl, chlorophenyl, dichlorophenyl, trichlorophenyl, difluorophenyl, methylphenyl, dimethylphenyl, trimethylphenyl, ethyl-phenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl.

C₅-C₁₂-Cycloalkyl which may optionally be substituted by functional groups, aryl, alkyl, aryloxy, halogen, heteroatoms and/or heterocycles is, for example, cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl or a saturated or unsaturated bicyclic system such as norbornyl or norbornenyl.

A five- or six-membered, oxygen-, nitrogen- and/or sulfur-comprising heterocycle is, for example, furyl, thiophenyl, pyrryl, pyridyl, indolyl, benzoxazolyl, dioxolyl, dioxyl, benzimidazolyl, benzthiazolyl, dimethylpyridyl, methylquinolyl, dimethylpyrryl, methoxyfuryl, dimethoxypyridyl, difluoropyridyl, methylthiophenyl, isopropylthiophenyl or tert-butylthiophenyl.

Preferred anions are selected from the group of halides and halogen-comprising compounds, the group of carboxylic acids, the group of sulfates, sulfites and sulfonates and the group of phosphates, in particular from the group of halides and halogen-comprising compounds, the group of carboxylic acids, the group consisting of SO₄²—, SO₃²—, R^{a}OSO₃— and R^{a}SO₃—, and the group consisting of PO₄³— and R^{a}R^{b}PO₄—.

Preferred anions are chloride, bromide, iodide, SCN—, OCN—, CN—, acetate, C₁-C₄-alkylsulfates, R^{a}—COO—, R^{a}SO₃—, R^{a}R^{b}PO₄—, methanesulfonate, tosylate or C₁-C₄-dialkylphosphates.

Particularly preferred anions are Cl—, CH₃COO—, C₂H₅COO—, C₆H₅COO—, CH₃SO₃—, (CH₃O)₂PO₂— or (C₂H₅O)₂PO₂—.

In a further preferred embodiment, use is made of ionic liquids of the formula I in which
[A]ₙ⁺ is 1-methylimidazolium, 1-ethylimidazolium, 1-(1-butyl)imidazolium, 1-(1-octyl)-imidazolium, 1-(1-dodecyl)imidazolium, 1-(1-tetradecyl)imidazolium, 1-(1-hexadecyl)imidazolium, 1,3-dimethylimidazolium, 1-ethyl-3-methylimidazolium, 1-(1-butyl)-3-methylimidazolium, 1-(1-butyl)-3-ethylimidazolium, 1-(1-hexyl)-3-methylimidazolium, 1-(1-hexyl)-3-ethylimidazolium, 1-(1-hexyl)-3-butyl-imidazolium, 1-(1-octyl)-3-methylimidazolium, 1-(1-octyl)-3-ethylimidazolium, 1-(1-octyl)-3-butylimidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethylimidazolium, 1,4-dimethyl-3-butylimidazolium, 1,4-dimethyl-3-octyl-imidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium or 1-(prop-1-en-3-yl)-3-methylimidazolium; and
[Y]ₙ⁺ is Cl—, CH₃COO—, C₂H₅COO—, C₆H₅COO—, CH₃SO₃—, (CH₃O)₂PO₂— or (C₂H₅O)₂PO₂—.

In the process of the invention, an ionic liquid of the formula I or a mixture of ionic liquids of the formula I is used; preference is given to using an ionic liquid of the formula I.

In a further embodiment of the invention, it is possible to use an ionic liquid of the formula II or a mixture of ionic liquids of the formula II; preference is given to using an ionic liquid of the formula II.

In a further embodiment of the invention, it is possible to use a mixture of ionic liquids of the formulae I and II.

In the process of the invention, inorganic acids, organic acids or mixtures thereof are used as acid.

Examples of inorganic acids are hydrohalic acids such as HF, HCl, HBr or Hi, perhalic acids such as HClO₄, halic acids such as HClO₃, sulfur-comprising acids such as H₂SO₄, polysulfuric acid or H₂SO₃, nitrogen-comprising acids such as HNO₃ or phosphorus-comprising acids such as H₃PO₄, polyphosphoric acid or H₃PO₃. Preference is given to using hydrohalic acids such as HCl or HBr, H₂SO₄, HNO₃ or H₃PO₄, in particular HCl, H₂SO₄ or H₃PO₄.

Examples of organic acids are carboxylic acids such as
C₁-C₆-alkanecarboxylic acids, for example acetic acid, propionic acid, n-butanecarboxylic acid or pivalic acid,
dicarboxylic or polycarboxylic acids, for example succinic acid, maleic acid or fumaric acid,
hydroxycarboxylic acids, for example hydroxyacetic acid, lactic acid, malic acid or citric acid;
halogenated carboxylic acids, for example C₁-C₆-haloalkanecarboxylic acids, e.g. fluoroacetic acid, chloroacetic acid, bromoacetic acid, difluoroacetic acid, dichloroacetic acid, chlorofluoroacetic acid, trifluoroacetic acid, trichloroacetic acid, 2-chloropropionic acid, perfluoropropionic acid or perfluorobutanecarboxylic acid,
aromatic carboxylic acids, for example arylcarboxylic acids such as benzoic acid;
   and sulfonic acids such as
C₁-C₆-alkanesulfonic acids, for example methanesulfonic acid or ethanesulfonic acid,
halogenated sulfonic acids, for example C₁-C₆-haloalkanesulfonic acids such as trifluoromethanesulfonic acid,
aromatic sulfonic acids, for example arylsulfonic acids such as benzenesulfonic acid or 4-methylphenylsulfonic acid.

Preference is given to using C₁-C₆-alkanecarboxylic acids, for example acetic acid or propionic acid, halogenated carboxylic acids, for example C₁-C₆-haloalkane-carboxylic acids, e.g. fluoroacetic acid, chloroacetic acid, difluoroacetic acid, dichloroacetic acid, chlorofluoroacetic acid, trifluoroacetic acid, trichloroacetic acid or perfluoropropionic acid, or sulfonic acids such as C₁-C₆-alkanesulfonic acids, for example methanesulfonic acid or ethanesulfonic acid, halogenated sulfonic acids, for example C₁-C₆-haloalkanesulfonic acids such as trifluoromethanesulfonic acid, or arylsulfonic acids such as benzenesulfonic acid or 4-methylphenylsulfonic acid as organic acids. Preference is given to using acetic acid, chlorofluoroacetic acid, trifluoroacetic acid, perfluoropropionic acid, methanesulfonic acid, trifluoromethane-sulfonic acid or 4-methylphenylsulfonic acid.

In a particular embodiment of the invention, sulfuric acid, acetic acid, trifluoroacetic acid, methanesulfonic acid or 4-methylphenylsulfonic acid is used as acid. If 4-methylphenylsulfonic acid monohydrate is used, one equivalent of water is present at the same time.

In a particular embodiment, ionic liquids and acids whose anions are identical are used. These anions are preferably acetate, trifluoroacetate, chloride or bromide.

In a further particular embodiment, ionic liquids and acids whose anions are not identical are used.

The degradation according to the invention of cellulose can be carried out using celluloses from a wide variety of sources, e.g. from cotton, flax, ramie, straw, bacteria, etc., or from wood or bagasse, in the cellulose-enriched form.

However, the process of the invention can be used not only for the degradation of cellulose but generally for the cleavage or degradation of polysaccharides, oligosaccharides and disaccharides and also derivatives thereof. Examples of polysaccharides are, in addition to cellulose and hemicellulose, starch, glycogen, dextran and tunicin. Polysaccharides likewise include the polycondensates of D-fructose, e.g. inulin, and also, inter alia, chitin and alginic acid. Sucrose is an example of a disaccharide. Possible cellulose derivatives are, inter alia, cellulose ethers such as methylcellulose and carboxymethylcellulose, cellulose esters such as cellulose acetate, cellulose butyrate and cellulose nitrate. The relevant statements made above apply analogously for this purpose.

In the process of the invention, a solution of cellulose in an ionic liquid is prepared. The concentration of cellulose can here be varied within a wide range. It is usually in the range from 0.1 to 50% by weight, based on the total weight of the solution, preferably from 0.2 to 40% by weight, particularly preferably from 0.3 to 30% by weight and very particularly preferably from 0.5 to 20% by weight.

This dissolution process can be carried out at room temperature or with heating, but above the melting point or softening temperature of the ionic liquid, usually at a temperature of from 0 to 200° C., preferably from 20 to 180° C., particularly preferably from 50 to 150° C. However, it is also possible to accelerate the dissolution process by intensive stirring or mixing and by introduction of microwave energy or ultrasonic energy or by means of a combination of these.

The acid and if appropriate water is then added to the solution obtained in this way. The addition of water may be necessary if the water adhering to the cellulose used is insufficient to reach the desired degree of degradation. In general, the water content of conventional cellulose is in the range from 5 to 10% by weight, based on the total weight of the cellulose used (cellulose+adhering water). By using an excess of water and acid based on the anhydroglucose units of the cellulose, complete degradation as far as glucose is also possible. To reach partial degradation, substoichiometric amounts of water and acid are added or the reaction is stopped at that point.

In another embodiment, the ionic liquid, acid and if appropriate water are premixed and the cellulose is dissolved in this mixture.

It is also possible for one or more further solvents to be added to the reaction mixture or to be introduced with the ionic liquid and/or the acid and/or if appropriate the water. Possible solvents here are those which do not have an adverse effect on the solubility of the cellulose, e.g. aprotic dipolar solvents, for example dimethyl sulfoxide, dimethylformamide, dimethylacetamide or sulfolane.

In a particular embodiment, the reaction mixture comprises less than 5% by weight, preferably less than 2% by weight, in particular less than 0.1% by weight of further solvents, based on the total weight of the reaction mixture.

The hydrolysis is, depending on the ionic liquid used and the acid used, usually carried out at a temperature in the range from the melting point of the ionic liquid to 200° C., preferably from 20 to 180° C., in particular from 50 to 150° C.

The reaction is usually carried out at ambient pressure. However, it can also be advantageous, on a case-to-case basis, to work under superatmospheric pressure, particularly when volatile acids are used.

In general, the reaction is carried out in air. However, it is also possible to work under inert gas, i.e., for example, under N₂, a noble gas, CO₂ or a mixture thereof.

The reaction time is usually in a range from 1 to 24 hours.

The amount of acid used, the water to be added if appropriate, in each case relative to the cellulose used, the reaction time and, if appropriate, the reaction temperature are set as a function of the desired degree of degradation.

If, for example, the cellulose which is on average made up of x anhydroglucose units is to be degraded completely to glucose, then x equivalents of water are required. Here, preference is given to using the stoichiometric amount of water (n_{anhydroglucose units}/n_{acid}=1) or an excess, preferably an excess of >3 mol % based on x. The acid can be used in catalytic amounts here, preferably in the range from 1 to 50 mol % based on x. However, it is also possible to increase the acid content up to the stoichiometric ratio (relative to x) or in excess.

If the cellulose which is on average made up of x anhydroglucose units is to be converted into a cellulose whose number of anhydroglucose units is less than x, the amounts of water used and acid used is usually adapted accordingly (n_{anhydroglucose units}/n_{acid}=1). The larger the ratio of n_{anhydroglucose units}/n_{acid}, the lower the average degradation of cellulose under otherwise identical reaction conditions and identical reaction time. The larger the ratio of n_{anhydroglucose units}/n_{water}, the lower the average degradation of cellulose under otherwise identical reaction conditions and identical reaction time.

Furthermore, it is possible to stop the hydrolysis reaction when the desired degree of degradation has been reached by separating off the cellulose from the reaction mixture. This can be effected, for example, by cooling of the reaction mixture and subsequent addition of an excess of water or another suitable solvent in which the degraded cellulose is not soluble, e.g. a lower alcohol such as methanol, ethanol, propanol or butanol, or a ketone, for example acetone, etc., or mixtures thereof. Preference is given to using an excess of water or methanol.

It is also possible to stop the hydrolysis reaction when the desired degree of degradation has been reached by precipitating the cellulose out of the reaction mixture, without the reaction mixture having been cooled beforehand.

It is also possible to introduce the reaction mixture into water or into another suitable solvent in which the degraded cellulose is not soluble, e.g. a lower alcohol such as methanol, ethanol, propanol or butanol or a ketone, for example acetone, etc., or mixtures thereof and, depending on the embodiment, obtain, for example fibers, films etc. of degraded cellulose. The filtrate is worked up as described above.

It is also possible to stop the hydrolysis reaction when the desired degree of degradation has been reached by scavenging the acid with a base. Suitable bases are both inorganic bases, e.g. alkali metal hydroxides, carbonates, hydrogencarbonates, and organic bases, e.g. amines, which are used in a stoichiometric ratio relative to the acid or in excess. In a further embodiment, a hydroxide whose cation corresponds to the ionic liquid used can be used as base.

The reaction mixture is usually worked up by precipitating the cellulose as described above and filtering off the cellulose. The ionic liquid can be recovered from the filtrate using customary methods, by distilling off the volatile components such as the precipitant, the water added if appropriate and, if volatile acids such as organic acids were used, the latter, or if appropriate further solvents. The ionic liquid which remains can be reused in the process of the invention. In a further embodiment, excess nucleophile can also remain in the ionic liquid and be reused in the process of the invention.

However, if work-up is carried out without neutralization, the acid can also remain in the ionic liquid after removal of the solvent and the mixture can (if appropriate after addition of water) be used further for the cellulose degradation.

Owing to the random degradation of the cellulose, the ionic liquid to be regenerated comprises only little glucose or its oligomers. Any amounts of these compounds present can be separated off from the ionic liquid by extraction with a solvent or by addition of a precipitant.

If reaction conditions under which the cellulose is degraded completely are chosen, the corresponding glucose can be separated off from the ionic liquid by customary methods, e.g. precipitation with ethanol.

If the ionic liquid is to be recirculated in a cyclic mode of operation, the ionic liquid can comprise up to 15% by weight, preferably up to 10% by weight, in particular up to 5% by weight, of precipitant(s) as described above.

The process can be carried out batchwise, semicontinuously or continuously.

The following examples serve to illustrate the invention.

Preliminary remark:

Cotton linters (hereinafter referred to as linters) or Avicel PH 101 (microcrystalline cellulose) were dried overnight at 80° C. and 0.05 mbar.

The ionic liquids were dried overnight at 120° C. and 0.05 mbar with stirring. The ionic liquids then comprise about 200 ppm of water.

All examples with a controlled water content were carried out in an atmosphere of dry argon.

The average degree of polymerization DP of the cellulose used (if necessary) and of the degraded cellulose was determined in each case by measurement of the viscosity in Cuen solution.

### ABBREVIATIONS

BMIM Cl 1-butyl-3-methylimidazolium chloride
EMIM Cl 1-ethyl-3-methylimidazolium chloride
BMMIM Cl 1-butyl-2,3-dimethylimidazolium chloride
DP average degree of polymerization
AGU anhydroglucose unit

### EXAMPLE 1

### Complete Degradation of Cellulose in BMIM Cl by Means of Trifluoroacetic Acid at 100° C.

In a 50 ml protective gas flask with magnetic stirrer rod, 0.5 g of dried linters was stirred in 20.0 g of BMIM Cl at 120° C. until a clear solution was formed. After cooling to 100° C., 0.1 g of trifluoroacetic acid and 0.05 g of water were added. (The ratio of AGUs to acid was 3.5:1, and that of AGUs to water was 1:1.) The reaction mixture was stirred at 100° C. for 16 hours; part of the mixture was then precipitated in twenty times the amount of water and another part was precipitated in twenty times the amount of methanol. In both cases, no precipitate was formed and only low molecular weight constituents were found in the gel chromatogram, which corresponds to complete degradation of the cellulose.

### EXAMPLE 2

### Complete Degradation of Cellulose in BMIM Cl by Means of Trifluoroacetic Acid at 120° C.

In a 50 ml protective gas flask with magnetic stirrer rod, 0.5 g of dried linters was stirred in 20.0 g of BMIM Cl at 120° C. until a clear solution was formed. 0.1 g of trifluoroacetic acid and 0.05 g of water were added to this clear solution. (The ratio of AGUs to acid was 3.5:1, and that of AGUs to water was 1:1.) The reaction mixture was stirred at 120° C. for 4 hours; part of the mixture was then precipitated in twenty times the amount of water and another part was precipitated in twenty times the amount of methanol. In both cases, no precipitate was formed and only low molecular weight constituents were found in the gel chromatogram, which corresponds to complete degradation of the cellulose.

### EXAMPLE 3

### Partial Degradation of Cellulose in BMIM Cl by Means of Trifluoroacetic Acid at 100° C.

In a 50 ml protective gas flask with magnetic stirrer rod, 0.5 g of dried linters was stirred in 19.5 g of BMIM Cl at 120° C. until a clear solution was formed. After cooling to 100° C., 2.85 mg of trifluoroacetic acid dissolved in 0.5 g of BMIM Cl were added to the clear solution. (The ratio of AGUs to acid was 125:1.) The reaction mixture was stirred at 100° C. for 16 hours; the reaction mixture was then precipitated in twenty times the amount of methanol. The precipitate was filtered off, washed with methanol and dried overnight at 80° C. and 1 mbar. The yield of cellulose was 0.47 g (94%). The DP of the cellulose obtained in this way was 171. The DP of the linters used was 3252.

### EXAMPLE 4

### Complete Degradation of Cellulose in BMIM Cl by Means of P-Toluenesulfonic Acid Monohydrate at 100° C.

In a 25 ml protective gas flask with magnetic stirrer rod, 0.5 g of dried Avicel PH 101 was stirred in 10.0 g of BMIM Cl at 120° C. until a clear solution was formed. After cooling to 100° C., 0.586 g of p-toluenesulfonic acid monohydrate was added to the clear solution. (The ratio of AGUs to acid was 1:1 and that of AGUs to water was likewise 1:1). The reaction mixture was stirred at 100° C. for 2 hours; part of the mixture was then precipitated in twenty times the amount of water and another part was precipitated in twenty times the amount of methanol. In both cases, no precipitate was formed and only low molecular weight constituents were found in the gel chromatogram, which corresponds to complete degradation of the cellulose.

### EXAMPLE 5

### Complete Degradation of Cellulose in BMIM Cl by Means of P-Toluenesulfonic Acid at 100° C.

In a 25 ml protective gas flask with magnetic stirrer rod, 0.5 g of dried Avicel PH 101 was stirred in 10.0 g of BMIM Cl at 120° C. until a clear solution was formed. After cooling to 100° C., 0.531 g of anhydrous p-toluenesulfonic acid was added to the clear solution. (The ratio of AGUs to acid was 1:1.) The reaction mixture was stirred at 100° C. for 2 hours; part of the mixture was then precipitated in twenty times the amount of water and another part was precipitated in twenty times the amount of methanol. In both cases, no precipitate was formed and only low molecular weight constituents were found in the gel chromatogram, which corresponds to complete degradation of the cellulose.

### EXAMPLE 6

### Partial Degradation of Cellulose in BMIM Cl by Means of P-Toluenesulfonic Acid Monohydrate at 100° C.

In a 25 ml protective gas flask with magnetic stirrer rod, 0.5 g of dried linters was stirred in 9.5 g of BMIM Cl at 120° C. until a clear solution was formed. After cooling to 100° C., 5.86 mg of p-toluenesulfonic acid monohydrate dissolved in 0.5 g of BMIM Cl were added to the clear solution. (The ratio of AGUs to acid was 100:1 and that of AGUs to water was likewise 100:1). The reaction mixture was stirred at 100° C. for 6 hours, and the mixture was then precipitated in twenty times the amount of methanol. The precipitate was filtered off, washed with methanol and dried overnight at 80° C. and 1 mbar. The yield of cellulose was 0.485 g (97%). The DP of the cellulose obtained in this way was 187. The DP of the linters used was 3252.

### EXAMPLE 7

### Complete Degradation of Cellulose in BMIM Cl by Means of Phosphoric Acid at 100° C.

In a 25 ml protective gas flask with magnetic stirrer rod, 0.5 g of dried Avicel PH 101 was stirred in 10.0 g of BMIM Cl at 120° C. until a clear solution was formed. After cooling to 100° C., 0.5 g of 60% strength by weight phosphoric acid was added to the clear solution. (The ratio of AGUs to acid was 1:1 and that of AGUs to water was 1:3.6). The reaction mixture was stirred at 100° C. for 6 hours; part of the mixture was then precipitated in twenty times the amount of water and another part was precipitated in twenty times the amount of methanol. In both cases, no precipitate was formed and only low molecular weight constituents were found in the gel chromatogram, which corresponds to complete degradation of the cellulose.

### EXAMPLE 8

### Complete Degradation of Cellulose in EMIM Cl by Means of Trifluoroacetic Acid at 120° C.

In a 50 ml protective gas flask with magnetic stirrer rod, 0.5 g of dried linters was stirred in 20.0 g of EMIM Cl at 120° C. until a clear solution was formed. 0.1 g of trifluoroacetic acid and 0.05 g of water were added to this clear solution. (The ratio of AGUs to acid was 3.5:1, and that of AGUs to water was 1:1.) The reaction mixture was stirred at 120° C. for 4 hours; part of the mixture was then precipitated in twenty times the amount of water and another part was precipitated in twenty times the amount of methanol. In both cases, no precipitate was formed and only low molecular weight constituents were found in the gel chromatogram, which corresponds to complete degradation of the cellulose.

### EXAMPLE 9

### Partial Degradation of Cellulose in BMMIM Cl by Means of Trifluoroacetic Acid at 100° C.

In a 50 ml protective gas flask with magnetic stirrer rod, 0.5 g of dried linters was stirred in 19.5 g of BMMIM Cl at 120° C. until a clear solution was formed. After cooling to 100° C., 2.85 mg of trifluoroacetic acid dissolved in 0.5 g of BMMIM Cl were added to the clear solution. (The ratio of AGUs to acid was 125:1.) The reaction mixture was stirred at 100° C. for 16 hours; the reaction mixture was then precipitated in twenty times the amount of methanol. The precipitate was filtered off, washed with methanol and dried overnight at 80° C. and 1 mbar. The yield of cellulose was 0.48 g (97%). The DP of the cellulose obtained in this way was 180. The DP of the linters used was 3252.

### EXAMPLE 10

### Partial Degradation of Cellulose in BMIM Cl by Means of Trifluoroacetic Acid at 100° C.

In a 50 ml protective gas flask with magnetic stirrer rod, 0.5 g of dried linters was stirred in 20.0 g of BMIM Cl at 120° C. until a clear solution was formed. After cooling to 100° C., 0.1 g of trifluoroacetic acid and 0.05 g of water were added. (The ratio of AGUs to acid was 3.5:1 and that of AGUs to water was 1:1.) The reaction mixture was stirred at 100° C. for 3 hours; the reaction mixture was then precipitated in twenty times the amount of methanol. The precipitate was filtered off, washed with methanol and dried overnight at 80° C. and 1 mbar. The yield of cellulose was 0.46 g (92%). The DP of the cellulose obtained in this way was 211. The DP of the linters used was 3252.

1. A process for the degradation of polysaccharides, oligosaccharides or disaccharides or derivatives thereof, wherein the polysaccharide, oligosaccharide or disaccharide or the corresponding derivative is dissolved in at least one ionic liquid and treated with at least one acid, if appropriate with addition of water.

2. The process according to claim 1, wherein a polysaccharide or a derivative thereof is used as polysaccharide, oligosaccharide or disaccharide or derivative thereof.

3. The process according to claim 2, wherein cellulose or a cellulose derivative is used as polysaccharide or derivative thereof.

4. The process according to claim 3, wherein cellulose is used as polysaccharide or derivative thereof.

5. The process according to claim 1, wherein the ionic liquid or mixture thereof is selected from among the compounds of the formula I,
[A]ₙ⁺[Y]ⁿ⁻ (I),
where
n is 1, 2, 3 or 4;
[A]⁺ is a quaternary ammonium cation, an oxonium cation, a sulfonium cation or a phosphonium cation; and
[Y]ⁿ⁻ is a monovalent, divalent, trivalent or tetravalent anion;
or
the compounds of the formula II
[A¹]⁺[A²]⁺[Y]ⁿ⁻ (IIa), where n=2;
[A¹]⁺[A²]⁺[A³]⁺[Y]ⁿ⁻ (IIb), where n=3; or
[A¹]⁺[A²]⁺[A³]⁺[A⁴]⁺[Y]ⁿ⁻ (IIc), where n=4, and
[A¹]⁺, [A²]⁺, [A³]+ and [A⁴]⁺ are selected independently from among the groups specified for [A]⁺; and
[Y]ⁿ⁻ is as defined above.

6. The process according to claim 5, wherein [A]⁺ is a cation selected from among the compounds of the formulae (IIIa) to (IIIy) 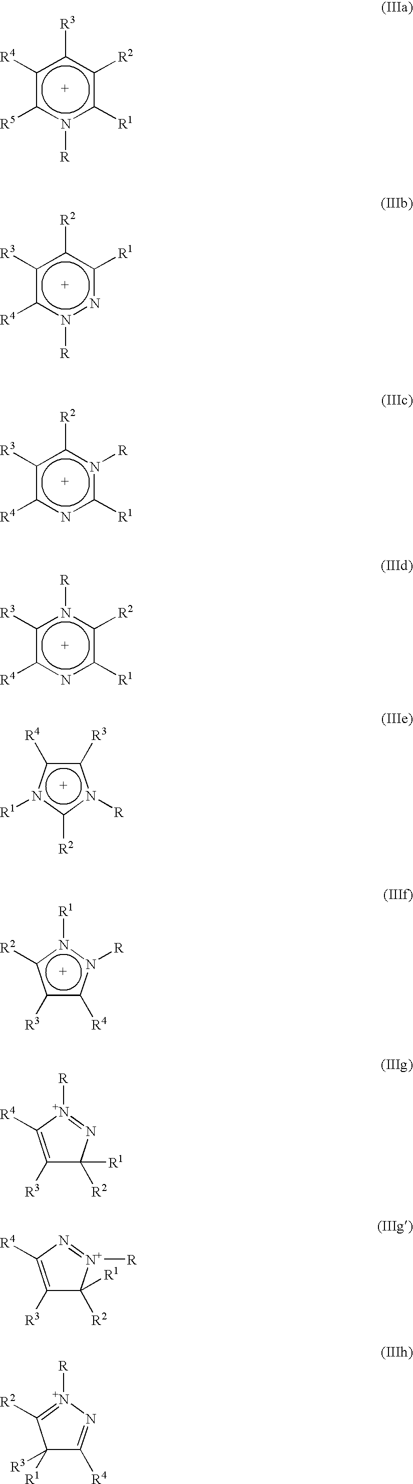 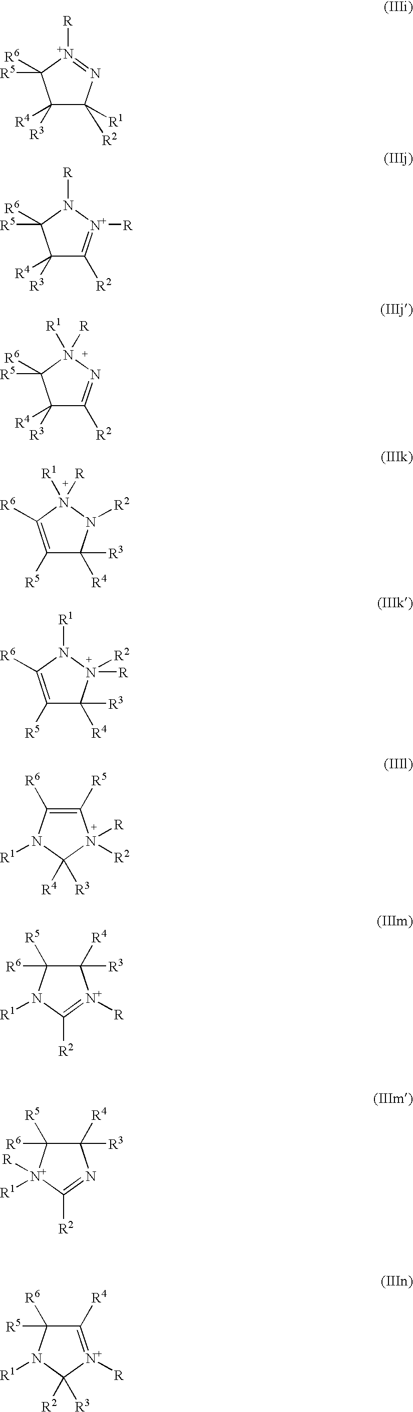 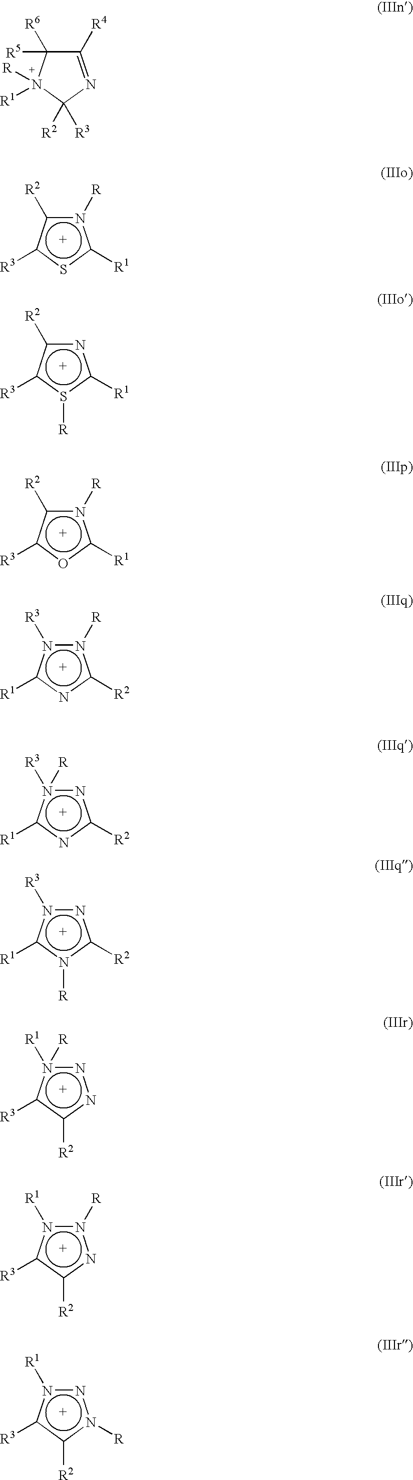 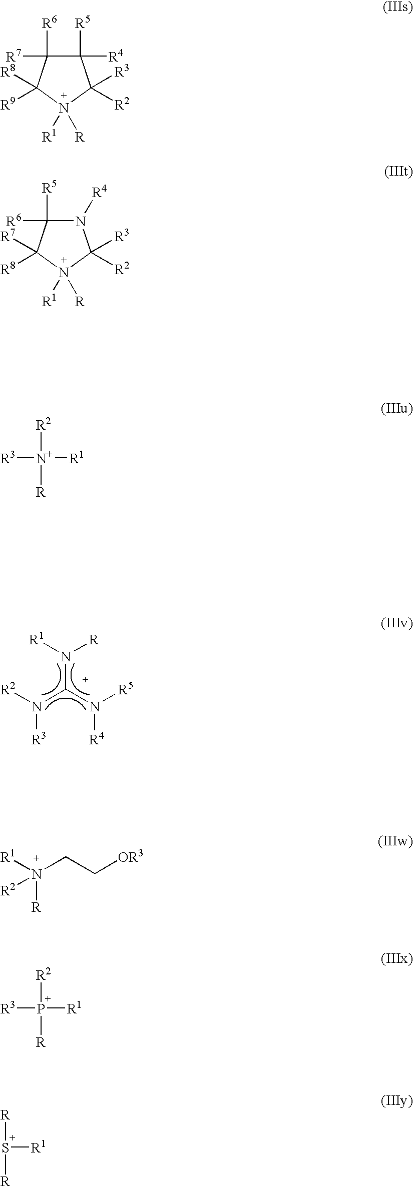
and oligomers comprising these structures, where
the radical R is hydrogen or a carbon-comprising organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or functional groups; and
the radicals R¹ to R⁹ are each, independently of one another, hydrogen, a sulfo group or a carbon-comprising organic, saturated or unsaturated, acyclic or cyclic, aliphatic, aromatic or araliphatic radical which has from 1 to 20 carbon atoms and may be unsubstituted or be interrupted or substituted by from 1 to 5 heteroatoms or functional groups, where the radicals R¹ to R⁹ which are bound to a carbon atom (and not to a heteroatom) in the abovementioned formulae (III) can additionally be halogen or a functional group; or
two adjacent radicals from the group consisting of R¹ to R⁹ may together also form a divalent, carbon-comprising organic, saturated or unsaturated, acyclic or cyclic, aliphatic, aromatic or araliphatic radical which has from 1 to 30 carbon atoms and may be unsubstituted or be interrupted or substituted by from 1 to 5 heteroatoms or functional groups.

7. The process according to claim 5, wherein [Y]ⁿ⁻ is an anion selected from among
the group of halides and halogen-comprising compounds of the formulae:
F⁻, Cl⁻, Br⁻, I⁻, BF₄⁻, PF₆⁻, CF₃SO₃⁻, (CF₃SO₃)₂N⁻, CF₃CO₂⁻, CCl₃CO₂⁻, CN⁻, SCN⁻, OCN⁻
the group of sulfates, sulfites and sulfonates of the general formulae: SO₄²⁻, HSO₄⁻, SO₃²⁻, HSO₃⁻, R^{a}SO₃⁻, R^{a}SO₃⁻
the group of phosphates of the general formulae PO₄³⁻, HPO₄²⁻, H₂PO₄⁻, R^{a}PO₄²⁻, HR^{a}PO₄⁻, R^{a}R^{b} PO₄⁻
the group of phosphonates and phosphinates of the general formulae: R^{a}HPO₃⁻, R^{a}R^{b}PO₂⁻, R^{a}R^{b}PO₃⁻
the group of phosphites of the general formulae: PO₃³⁻, HPO₃²⁻, H₂PO₃⁻, R^{a}PO₃²⁻, R^{a}HPO₃⁻, R^{a}R^{b}PO₃⁻
the group of phosphonites and phosphinites of the general formulae: R^{a}R^{b}PO₂⁻, R^{a}HPO₂⁻, R^{a}R^{b}PO⁻, R^{a}HPO⁻
the group of carboxylic acids of the general formula: R^{a}COO⁻
the group of borates of the general formulae: BO₃³⁻, HBO₃²⁻, H₂BO₃⁻, R^{a}R^{b}BO₃⁻, R^{a}HBO₃⁻, R^{a}BO₃²⁻, B(OR^{a})(OR^{b})(OR^{c})(OR^{d})⁻, B(HSO₄)⁻, B(R^{a}SO₄)⁻
the group of boronates of the general formulae: R^{a}BO₂²⁻, R^{a}R^{b}BO⁻
the group of silicates and silicic esters of the general formulae: SiO₄⁴⁻, HSiO₄³⁻, H₂SiO₄²⁻, H₃SiO₄⁻, R^{a}SiO₄³⁻, R^{a}R^{b}SiO₄²⁻, R^{a}R^{b}R^{c}SiO₄⁻, HR^{a}SiO₄²⁻, H₂R^{a}SiO₄⁻, HR^{a}R^{b}SiO₄⁻
the group of alkylsilane and arylsilane salts of the general formulae: R^{a}SiO₃³⁻, R^{a}R^{b}SiO₂²⁻, R^{a}R^{b}R^{c}C SiO⁻, R^{a}R^{b}R^{c}SiO₃⁻, R^{a}R^{b}R^{c}SiO₂⁻, R^{a}R^{b} SiO₃²⁻
the group of carboximides, bis(sulfonyl)imides and sulfonylimides of the general formulae: 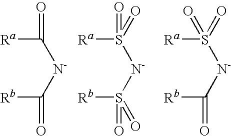
the group of methides of the general formula: 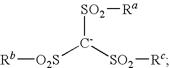
where the radicals R^{a}, R^{b}, R^{c} and R^{d} are each, independently of one another, hydrogen, C₁-C₃₀-alkyl, C₂-C₁₈-alkyl which may optionally be interrupted by one or more nonadjacent oxygen and/or sulfur atoms and/or one or more substituted or unsubstituted imino groups, C₆-C₁₄-aryl, C₅-C₁₂-cycloalkyl or a five- or six-membered, oxygen-, nitrogen- and/or sulfur-comprising heterocycle, where two of them may together form an unsaturated, saturated or aromatic ring which may optionally be interrupted by one or more oxygen and/or sulfur atoms and/or one or more unsubstituted or substituted imino groups, where the radicals mentioned may each be additionally substituted by functional groups, aryl, alkyl, aryloxy, alkyloxy, halogen, heteroatoms and/or heterocycles.

8. The process according to claim 6, wherein [A]⁺ is a cation selected from the group consisting of the compounds IIIa, IIIe, IIIf, IIIg, IIIg′, IIIh, IIIi, IIIj, IIIj′, IIIk, IIIk′, IIIl, IIIm, IIIm′, IIIn and IIIn′.

9. The process according to claim 6, wherein [A]⁺ is a cation selected from the group consisting of the compounds IIIa, IIIe and IIIf.

10. The process according to claim 5, wherein [Y]ⁿ⁻ is an anion selected from the group consisting of halides and halogen-comprising compounds, the group consisting of carboxylic acids, the group consisting of SO₄²⁻, SO₃²⁻, R^{a}OSO₃⁻ and R^{a}SO₃⁻ and the group consisting of PO₄³⁻ and R^{a}R^{b}PO₄⁻.

11. The process according to claim 1, wherein an inorganic acid, an organic acid or mixtures thereof are used as acid.

12. The process according to claim 1, wherein the concentration of polysaccharide, oligosaccharide or disaccharide or derivative thereof in the ionic liquid is in the range from 0.1 to 50% by weight, based on the total weight of the solution.

13. The process according to claim 1, wherein the degradation is carried out at a temperature in the range from the melting point of the ionic liquid to 200° C.

14. The process according to claim 1, wherein the degradation is quenched by addition of a solvent in which the degradation products of the polysaccharide are not soluble.

15. The process according to claim 1, wherein the degradation is quenched by addition of base.
